(19) United States
(12) Patent Application Publication
(10) Pub. No.: US 2020/0097874 A1
(43) Pub. Date: Mar. 26, 2020

(54) Method and System for Managing and/or Monitoring a Project or a Process

(71) Applicant: Robert Bosch GmbH, Stuttgart (DE)

(72) Inventors: Stefan Wannenmacher, Ostelsheim (DE); Joachim Schadow, Stuttgart (DE); Wolfgang Baierl, Schorndorf (DE); Stefan Gaa, Mannheim (DE); Joern Stock, Leinfelden-Echterdingen (DE); Florian Esenwein, Leinfelden-Echterdingen (DE); Andreas Golob, Neuhausen A.D.F. (DE)

(21) Appl. No.: 16/498,508

(22) PCT Filed: Mar. 23, 2018
(86) PCT No.: PCT/EP2018/057439

§ 371 Date: Oct. 30, 2019

(30) Foreign Application Priority Data
Mar. 29, 2017 (DE) 10 2017 205 332.1
Mar. 22, 2018 (DE) 10 2018 204 417.1

(51) Int. Cl. G06Q 10/06

(52) U.S. Cl. CPC G06Q 10/06313; G06Q 10/0633

(57) ABSTRACT

A method for managing and/or monitoring a project, in particular a building project, and/or a process, in particular a building use, includes using at least one capture unit to capture parameter values of at least one parameter at different stipulable positions of a monitoring area in automated fashion. The method further includes transmitting the parameter values in automated fashion to at least one external unit via at least one communication unit.

### PRIOR ART

The prior art discloses methods and systems for managing and/or monitoring projects, such as for example building projects, or processes, such as for example a building use.

### DISCLOSURE OF THE INVENTION

The invention sets out from a method for managing and/or monitoring a project, in particular a building project, and/or a process, in particular a building use, advantageously from a project management method and/or from a process management method, in particular for project performance, project monitoring, process handling and/or process monitoring, in particular on at least one building site and/or in at least one and/or for at least one building.

It is proposed that at least one method step involves at least one recording unit being used to record in particular location-dependent and/or time-dependent and/or different and/or variable parameter values of at least one parameter at different stipulable positions in a monitoring area in automated fashion and at least one method step involves the parameter values being transmitted in automated fashion to at least one external unit by means of at least one communication unit.

The refinement according to the invention allows advantageous properties to be attained in respect of information recording and/or presentation. Further, it is advantageously possible for different information to be presented and/or conditioned transparently. Additionally, a user can, in an advantageous manner, quickly and easily query different progress parameters or the like and/or present them in project-related fashion and/or in process-related fashion. Further, navigation can advantageously be rendered possible, in particular in areas with electronically inadequate cartography, for example a building site or a building. In particular, an existing database of location-dependent information can be extended in selective and/or process-related and/or project-related fashion. Preferably, navigation is possible in all areas of a building parcel, a building site and/or a building. Additionally, different location-dependent parameters can be recorded and/or located easily and reliably. Furthermore, processes and/or project steps and/or project phases can be visualized transparently, which allows in particular a high level of user convenience and/or a high level of efficiency to be attained.

In this context, a “building project” is supposed to be understood to mean in particular at least one subproject of a building scheme, for example the erecting and/or converting of at least one construction such as for example a building, a plot of land, a road, a bridge, a park, a building stock or the like. In particular, the building project can comprise multiple project steps and/or project phases taking place consecutively and/or in parallel. In this context, a “building use” is supposed to be understood to mean in particular a commercial and/or private use of at least part of at least one building, for example an office building, a production building, an industrial building, a research building, a residential building and/or a hotel building or the like. In particular, the monitoring area comprises at least part of a building parcel and/or a plot of land and/or a building. Preferably, the project and/or the process proceed(s) at least in part within the monitoring area and/or is performed within said monitoring area.

Preferably, the positions are stipulable by a user, for example by a site manager and/or a building manager and/or the representatives of the latter or the like. By way of example, the positions can be prominent points on a building site, on a building parcel, on a building or the like. In particular, the positions can be associated with and/or arranged in for example rooms, parts of buildings, parts of building sites, storeys or at least parts of such like. In particular, the recording unit can be in the form of a central recording unit that is intended in particular to record parameter values at the different stipulable positions. By way of example, the recording unit can comprise at least one keyboard and/or a mouse and/or an input device and/or a camera and/or a smartphone and/or smart glasses and/or a tablet PC and/or a wearable and/or a sensor or the like and/or can be in the form of such like and/or can be part of such like. Preferably, the recording unit has at least one sensor intended to record parameter values of the parameter at at least one, in particular at precisely one, of the positions. Particularly preferably, at least one method step involves at least some of the positions, advantageously each of the positions, being assigned at least one, in particular precisely one, recording unit, in particular uniquely. Advantageously, the method according to the invention involves each of the positions having precisely one associated recording unit. “Intended” is supposed to be understood to mean in particular specifically programmed, designed and/or equipped. An object being intended for a specific function is supposed to be understood to mean in particular that the object performs and/or carries out this specific function in at least one application state and/or operating state.

Advantageously, the communication unit is intended for a wireless and/or a wired transmission of the parameter values to the external unit, in particular for a radio transmission, for example using WLAN, Bluetooth, ZigBee, NFC, Wibree or another wireless transmission method. It is also conceivable for the communication unit to be intended for a data transmission by means of at least one optical transmission, for example by means of flashes of light and/or by means of infrared light, it being conceivable, in particular in this case, for the external unit to be intended to receive and/or process applicable signals. Preferably, the communication unit is part of the recording unit and/or of at least partially integral design with the recording unit. In this context, a first object and a second object being “at least partially integrally” connected to one another is supposed to be understood to mean in particular that at least one element and/or part of the first object is integrally connected to at least one element and/or part of the second object. “Integrally” is supposed to be understood to mean in particular at least materially bonded, for example by means of a welding process, an adhesive process, an injection molding process and/or another process that appears appropriate to a person skilled in the art, and/or advantageously molded in one piece, such as for example by means of production from a cast and/or by means of production in a single-component or multi-component injection molding process and advantageously from a single blank.

In particular, the parameter can assume different parameter values that can be variable in particular over time and/or can differ in particular according to position. Advantageously, the recording unit is intended for a repeated recording and/or the communication unit is intended for a repeated transmission of parameter values, preferably at regular and/or selectable intervals of time, for example several times per hour or several times per minute, in particular at intervals of time of a few seconds, for example of approximately one second or of approximately two seconds or of approximately five seconds or of approximately ten seconds or the like, with arbitrary and/or variable intervals of time being conceivable. Preferably, the recording unit is in the form of an in particular independent sensor unit, in particular in the form of a sensor beacon. It is also conceivable for the recording unit to be in the form of a radio beacon and for the parameter value to be in particular a location parameter of the radio beacon. In particular, the recording unit has at least one in particular weatherproof housing and/or at least one, in particular wirelessly rechargeable, advantageously electrical energy store and/or at least one connecting element such as for example a plug for connection to an, in particular electrical, supply system. Preferably, the communication unit is arranged in the housing. Further, it is conceivable for the recording unit to be mountable, to have been mounted and/or to be mounted at at least one of the positions, for example on a floor, on a ceiling, in a corner, on a wall or the like. In particular, the recording unit can have at least one mounting element for mounting the recording unit at at least one of the positions.

In particular, the external unit can be in the form of a central unit. In particular, the external unit is in a different form than the recording unit and/or than the communication unit. It is conceivable for the external unit to be arranged inside or outside the monitoring area. In particular, the external unit can be a portable unit such as for example a smartphone, a laptop, a tablet PC, smart glasses or smart watch, a smart band, a wearable and/or the like. It is also conceivable for the external unit to be in the form of a server and/or a cloud and/or a control center, in particular a company headquarters, and/or a computing center and/or at least part of an IT infrastructure or the like and/or to be formed by such like. Preferably, the external unit is intended to allow access to a BIM (Building Information Model). In particular, the BIM can be stored in the external unit and/or can be operable by the external unit, at least in part. Alternatively, it is conceivable for the BIM to be stored physically separately from the external unit, for example in a computing center, on a server, in a cloud, or the like, and for the external unit to be able to be used to access the BIM, preferably wirelessly. In particular, the BIM is in the form of an, in particular dynamically adaptable, data record comprising relevant information about the project, preferably all of the relevant information about the project. In particular, the BIM comprises information about personnel, tools, materials or the like needed for the project and/or a schedule at least for completion of at least sections of the project and/or further information that appears relevant to the project to a person skilled in the art. Preferably, the external unit has at least one output unit, in particular a display and/or another visual indicator and/or a loudspeaker and/or a haptic display unit and/or a projector or the like. Advantageously, the external unit has at least one computing unit intended for performing at least one data processing. It is also conceivable for the external unit to be connectable to a cloud and/or a server and/or for the parameter values to be transmitted from the communication unit to a server, a cloud or the like and transmitted from there to the external unit. Further, in particular if the external unit is in the form of a server or a cloud or the like, it is conceivable for the external unit to be intended to transmit data to at least one, in particular mobile, terminal of the user.

In addition, it is proposed that at least one method step involves at least one parameter value of at least one parameter being recorded by means of the recording unit by means of an, in particular bidirectional, communication with at least one construction unit. A construction unit is in particular a unit that is usable for realizing a building project and is preferably arranged in the monitoring area, in particular on a building site. The construction unit can be in particular in the form of building material, such as for example in the form of a window, pallet, insulating material or the like, in the form of a work machine, such as for example in the form of a crane, in the form of a forklift truck, in the form of an excavator or the like, in the form of a machine tool, such as for example in the form of a drill, in the form of a circular saw, in the form of an angle grinder or the like, in the form of a safety item, such as for example in the form of a riser, in the form of a parapet, in the form of railings or the like, or in the form of another construction unit that appears appropriate to a person skilled in the art. Preferably, the construction unit has at least one parameter, such as for example a position of the construction unit, a state of charge of the construction unit, a genre of the construction unit, an identifier of the construction unit, a state of use of the construction unit or the like. Preferably, the recording unit is intended to record a plurality of parameter values of parameters of a plurality of construction units, in particular all the construction units associated with a monitoring area of the recording unit. Preferably, the construction unit is intended at least for an, in particular wireless, emission of a signal that is recordable in particular by the recording unit. Preferably, the signal comprises at least one parameter value of a parameter of the construction unit, in particular in the form of electronic data. The construction unit comprises in particular a, preferably wireless, communication unit at least for an emission of the signal. The communication unit can be in particular in the form of a radio module, in the form of a WLAN module, in the form of a Bluetooth module, in the form of an NFC module, in the form of a Zigbee module, in the form of a Wibree module or in the form of another communication unit that appears appropriate to a person skilled in the art. Alternatively, it is conceivable for the communication unit to be intended for a data transmission by means of at least one optical transmission, for example by means of flashes of light and/or by means of infrared light, or for the communication unit to be in the form of a wired communication unit intended for a communication with the recording unit, in particular with the communication unit of the recording unit, via a cable connection, for example via an Ethernet connection or the like.

Preferably, the construction unit is intended, in particular via the communication unit of the construction unit, for a bidirectional communication with the recording unit, in particular via the communication unit of the recording unit. In particular, the construction unit is intended, in particular by means of the communication unit of the construction unit, for a reception of signals of the recording unit, in particular of the communication unit of the recording unit. Preferably, the recording unit is intended, in particular by means of the communication unit of the recording unit, to query at least one parameter value of a parameter of the construction unit, in particular selectively. Preferably, the recording unit is intended to record the construction unit according to the genre of the construction unit and particularly preferably, in particular on the basis of an identifier of the construction unit, as a dedicated element. Preferably, the recording unit is intended, in particular on the basis of the identifier of the construction unit, to query at least one parameter value of at least one parameter of the construction unit, such as for example a specific property of the construction unit, a maintenance date for maintenance of the construction unit, a date of acquisition of the construction unit, a history of the construction unit or the like, from a database. Preferably, the external unit is in the form of a database, comprises at least one database and/or is intended to access a database. Preferably, the construction unit is intended to provide a parameter value of a parameter of the construction unit, in particular by means of the communication unit, to the database, in particular to store it in the database. It is possible for advantageously precise monitoring of a monitoring area to be achieved. Advantageous realtime monitoring of construction units can be rendered possible.

In a further refinement of the invention, it is proposed that at least one method step involves the external unit being used to generate at least one blueprint at least from the parameter values of the parameter. In this context, a “blueprint” is supposed to be understood to mean in particular a site plan, a ground plan, a building plan, a building blueprint, a site blueprint, a plan of at least part of a construction, a BIM and/or the like. In particular, the blueprint can be schematic and/or in perspective and/or two-dimensional and/or three-dimensional and/or to scale. Preferably, the blueprint contains at least one location-dependent and/or at least one time-dependent presentation of the parameter values, such as for example a movement of a group of construction units and/or personnel or the like, and/or at least one location-dependent and/or time-dependent piece of information that is ascertained in particular by means of the external unit from the parameter values. Advantageously, a map, in particular a heat map, for the parameter, which map contains at least the parameter values of the parameter at the different positions, is presented in the blueprint. Preferably, at least one method step involves the blueprint being presented for the user, in particular on a display of the external unit. It is advantageously possible for a high level of transparency to be attained. Further, it is advantageously possible for project-related and/or process-related information to be reliably associated with specific locations and/or positions and/or for said association to be made available in easily comprehensible fashion.

Fundamentally, it is conceivable for at least one, in particular blueprint-dependent, action to be selectable, to be activatable, and/or to be performable in automated fashion, by means of the external unit. By way of example, in particular in the case of a building use, for example lighting control, ventilation control, a room reservation or the like can be performable by means of the external unit, in particular on the basis of the blueprint. Further, in particular in the case of a building project, it is conceivable for at least one activity association, a building instruction, a tool reservation, a building equipment reservation, a building equipment allocation, an acknowledgement of accomplished tasks and/or obtained materials or the like to be performable by means of the external unit in particular on the basis of the blueprint. Moreover, it is conceivable for at least partial closure or opening of a monitoring area to be performable by means of the external unit, in particular on a building site and in particular on the basis of the blueprint. In particular, the external unit can be used to open a monitoring area at least for authorized personnel if the recording unit has been used to ascertain the presence of all of the safety items, in particular safety items provided for in the BIM for the monitoring area, in the monitoring area. In particular, the external unit can be used to close a monitoring area at least for the use of specific construction units, for example angle grinders or the like, if the recording unit is used to ascertain a presence of hazardous materials, for example gasoline or the like, and/or of items at risk of damage, for example windows or the like, in the monitoring area. Preferably, the external unit, in particular using the BIM, can assign a work instruction and/or a place of use to personnel, in particular on the basis of work materials recorded by the recording unit at the place of use. In particular, in the absence of work materials, in particular work materials provided for in the BIM, at a place of use, the external unit can assign a different place of use to the personnel and/or can initiate sourcing of work materials.

Additionally, it is proposed that at least one method step involves the external unit being used to take the parameter values of the parameter as a basis for assigning to the blueprint at least one piece of, in particular location-dependent and/or time-dependent, status information, a piece of progress information, a piece of use information and/or a piece of navigation information that is ascertained in particular on the basis of the parameter values by means of the external unit and/or is/are assigned to the positions in the blueprint. In particular, the parameter can be a state parameter, a navigation parameter, for example a piece of information about the location of an applicable position, a locating parameter, a deficiency parameter, a parameter regarding remaining work to be accomplished, a hazard parameter, a parameter regarding a closed area and/or an area to be closed, a storage place parameter, a goods use parameter, a space use parameter, an environmental parameter such as in particular a temperature, an air humidity, an air pressure, a pollutant contamination, a concentration of specific compounds, an identifier, for example for a pallet, a tracking parameter, an emergency parameter, a handover parameter, a maintenance parameter, a parameter regarding accident prevention, a parameter regarding damage and/or failure of components, for example of illuminants or the like, a parameter regarding cleaning and/or a degree of soiling, a building progress parameter or the like. A hazard parameter can be in particular in the form of a risk of accident, for example a trip hazard or the like, in a monitoring area. Preferably, the external unit is intended to evaluate in particular accidents recorded by means of the recording unit, for example tripping, in the monitoring area and to initiate counter measures, preferably in automated fashion, for example to assign a risk of accident in the monitoring area to the blueprint, to close the monitoring area or the like. In particular, the recording unit can be intended to ascertain a building progress at a position associated with said recording unit. Preferably, the external unit is intended to ascertain, in particular on the basis of the BIM, whether the building progress is consistent with a schedule. In particular, the external unit is intended, in particular on the basis of the BIM and in particular in the event of delayed building progress, to check whether deadline clashes occur and/or whether restructuring of work is necessary. In particular, the external unit is able, in particular by means of the BIM, to propose countermeasures, such as for example prioritization of takes and/or work assignments, assignment of a task force, inspection by a site manager or the like, and/or to initiate said countermeasures in automated fashion. It is advantageously possible for an overview map of a monitoring area to be selectively complemented by information regarding a project and/or process to be monitored.

In addition, it is proposed that at least one method step involves at least one time-dependent and/or location-dependent data record, in particular at least one ground plan, which is independent of the parameter values of the at least one parameter, being used to generate the blueprint. Advantageously, the data record comprises a site plan, a building plan, a planning map or the like. In particular, the data record is a static data record. Alternatively, it is conceivable for the data record to comprise at least one piece of time-dependent information such as for example a scheduled progress, a process flow, a schedule, a calendar or the like. Preferably, the data record is independent of all of the parameter values ascertained by means of the recording unit. It is advantageously possible for externally available data to be extended by measured parameters.

In a further refinement of the invention, it is proposed that at least one method step involves the external unit being used to locate the blueprint on the basis of at least one geoparameter, in particular on the basis of at least one geographical map. By way of example, the blueprint is incorporated into an existing, in particular digital map and/or a map usable for navigation, a resultant overall map advantageously likewise being useable for navigation. Navigation on a building site and/or within a building can advantageously be rendered possible, for example when creating a route map, providing directions to an office and/or on a building site.

Further, it is proposed that at least one method step involves the recording unit being used to record further parameter values of at least one further parameter, which is different than the parameter, and the blueprint being generated from at least the further parameter values of the further parameter. In particular, maps and/or heat maps and/or other information created on the basis of the parameter values and the further parameter values are presented in the blueprint, in particular in superposed fashion. Advantageously, the external unit is intended to present a depiction of the blueprint, in particular information to be presented, in a manner selectable by a user. In particular, the further parameter can be in the form of one of the parameters described above. Preferably, the recording unit is intended to ascertain different parameter values of different parameters, in particular in time-dependent fashion, and/or to transmit said parameter values to the external unit by means of the communication unit. It is conceivable that the recording unit has accordingly different sensors for the different parameters. It is advantageously possible for different parameters to be ascertained and presented repeatedly and/or at the same time, which allows in particular multilayer monitoring of a process and/or of a project.

In a further refinement of the invention, it is proposed that at least one method step involves the external unit being used to take at least one time-dependent and/or location-dependent data record, which is independent of the parameter values of the at least one parameter, in particular on the basis of the aforementioned time-dependent and/or location-dependent data record, as a basis for ascertaining at least one proposed positioning parameter for the recording unit. Preferably, the external unit is intended to propose the positioning parameter to the user. In particular, the proposed positioning parameter is a position proposed for the recording unit within the monitoring area. By way of example, the external unit can be intended to use said data record to select suitable positions at which recording units must be positioned for reliable recording of parameter values. In particular, the proposed positioning parameter can be dependent on a probable radio connection quality, a probable building progress, a probable use of space or another probable parameter. In particular, the external unit can be intended to present the proposed positioning parameter in a map created in particular on the basis of said data record, advantageously a map of the monitoring area. Advantageously, at least one method step involves the recording unit being positioned in the monitoring area in accordance with the proposed positioning parameter, in particular by the user and/or by at least one person instructed by the user. Preferably, the data record is independent of all of the parameter values ascertained by means of the recording unit. It is advantageously possible for a high level of coverage of a monitoring area, in particular using suitable radio beacons, to be attained.

Additionally, it is proposed that at least one method step involves the external unit being used to assign a position of the recording unit to at least one piece of information of the time-dependent and/or location-dependent data record. In particular, a positioning of the recording unit at at least one of the stipulable positions in the monitoring area is registered and/or a piece of positioning information for the recording unit is stored. In particular, the recording unit is intended to transmit an, in particular unique, identification to the external unit, in particular by means of the communication unit, in particular to register the recording unit for the first time, advantageously as part of an arrangement of multiple recording units at the stipulable positions in the monitoring area. It is advantageously possible for an individually created distribution of recording units to be registered and/or to be located in a map of a monitoring area.

In addition, it is proposed that at least one method step involves the external unit being used to generate at least one process plan and/or at least one Gantt chart on the basis of the parameter values of the parameter. Advantageous properties in respect of a time efficiency and/or reliable control of processes and/or projects can be attained.

In a further aspect of the invention, which can be considered on its own or in combination with other described aspects, a method for project management is proposed, wherein at least one first graphical plan of a first plan type, specifically a Gantt chart or a process plan, in particular the Gantt chart or process plan created by means of the external unit, is used to automatically create at least one second graphical plan of a second plan type, which is different from the first plan type, specifically a process plan or a Gantt chart.

It is conceivable that a graphical plan of the first plan type is automatically created from the second graphical plan.

Further, it is conceivable that a breakdown of the first graphical plan is converted into a breakdown of the second graphical plan.

Additionally, it is proposed that a second data record, on which the second graphical plan is based, is determined at least in part from a first data record, on which the first graphical plan is based.

In addition, it is proposed that the first data record and/or the second data record is edited on the basis of at least one user input.

Advantageously, the first data record and/or the second data record is/are edited on the basis of a graphical input by a user.

Additionally, it is conceivable that the graphical input by the user comprises at least one change of length for a depicted bar.

Further, it is proposed that the first data record and the second data record are synchronized.

Furthermore, a project management apparatus having at least one computing unit is proposed that is intended for performing the described method. Advantageously, the computing unit has at least one graphical user interface. Preferably, the project management apparatus has a BIM and/or is intended to access a BIM.

Further, the invention comprises a system for managing and/or monitoring a project, in particular a building project, and/or a process, in particular a building use, in particular for performing a method according to the invention, having at least one recording unit, intended for automatically recording parameter values of at least one parameter at at least one stipulable position in a monitoring area, and having at least one communication unit, intended for transmitting the parameter values to at least one external unit in automated fashion. In particular, the system comprises a plurality of recording units arranged in particular at the stipulable positions. Further, it is conceivable that the system comprises a plurality of external units. By way of example, it is conceivable that different users can use their associated external units to make a connection to the at least one recording unit and/or to retrieve the described functionalities, in particular at the same time.

The refinement according to the invention allows advantageous properties in respect of information recording and/or presentation to be attained. Further, it is advantageously possible for different information to be presented and/or conditioned transparently. Additionally, a user can, in an advantageous manner, quickly and easily query different progress parameters or the like and/or present them in project-related and/or process-related fashion. Further, navigation in areas with electronically inadequate cartography, for example a building site or a building, can advantageously be rendered possible. In particular, an existing database of location-dependent information can be extended selectively and/or in process-related and/or project-related fashion. Preferably navigation is possible in all areas of a building parcel, a building site and/or a building. Additionally, different location-dependent parameters can be easily and reliably recorded and/or located.

The method according to the invention and/or the system according to the invention are not supposed to be restricted to the applications and embodiments described above in this case. In particular, to achieve a manner of operation described herein, the method according to the invention and/or the system according to the invention can have a different number of individual elements, parts and units and also method steps than a number cited herein. Moreover, values lying within the cited limits are also supposed to be deemed disclosed and arbitrarily employable for the value ranges specified in this disclosure.

### DRAWING

Further advantages are obtained from the description of the drawings that follows. The drawing depicts an exemplary embodiment of the invention. The drawing, the description and the claims contain numerous features in combination. A person skilled in the art will expediently also consider the features individually and combine them into useful further combinations.

In the drawing:

FIG. 1 shows a perspective depiction of a monitoring area,

FIG. 2 shows a perspective depiction of a subarea of the monitoring area and an external unit,

FIG. 3 shows a schematic flowchart for a method according to the invention,

FIG. 4 shows a schematic plan view of a blueprint of the monitoring area, and

FIG. 5 shows a schematic plan view of the blueprint of the monitoring area in a located form.

### DESCRIPTION OF THE EXEMPLARY EMBODIMENT

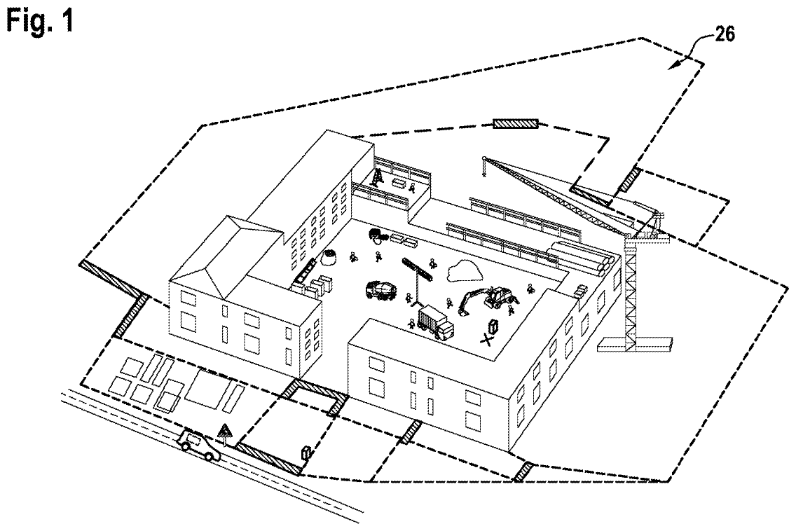

FIG. 1 shows a perspective depiction of a monitoring area 26. In the present case, the monitoring area 26 is in the form of a building parcel on a building site. A project is in progress within the monitoring area 26, in particular a building project. Further, at least one process is in progress within the monitoring area 26, in particular in connection with the building site, for example a process for laying foundations, a process for constructing a building, a process for laying out a garden or the like. The depiction below relates to a method for managing and/or monitoring a project, in particular a building project, and/or a process, in particular a building use, in exemplary fashion on the basis of the monitoring area 26 shown, and an applicable building project. It is conceivable that, additionally or alternatively, a monitoring area contains a finished building, in particular an office building, a residential building, an industrial building, an airport, a bridge or the like. Further, a monitoring area can comprise different subareas, in particular subareas arranged physically separately from one another, for example multiple subareas of a large building site and/or else multiple individual building sites. Further, the method described is not supposed to be restricted to buildings and/or building sites. Rather, it is conceivable to manage and/or monitor any other suitable projects and/or processes, for example within a company structure, an organization, an association, a sports team or the like, by means of the method.

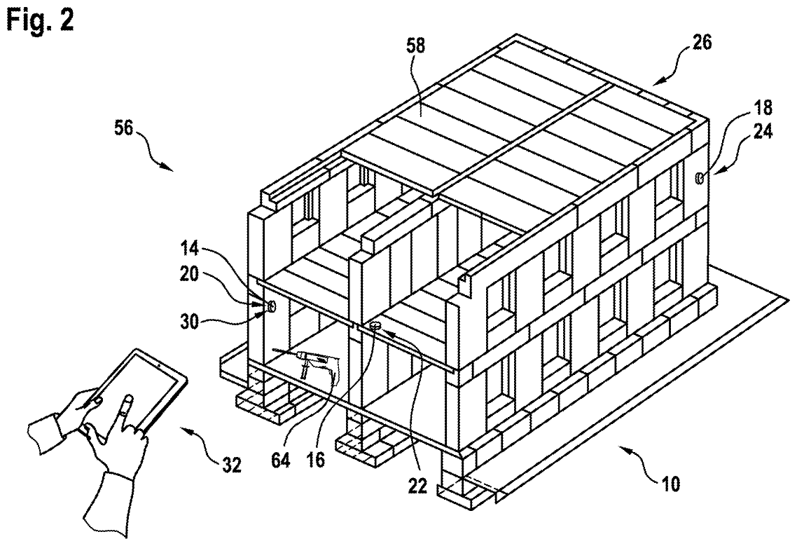

FIG. 2 shows a perspective depiction of a subarea 56 of the monitoring area 26. The subarea 56 contains a building 58 that is being constructed. Further, FIG. 2 shows part of a system 10 for managing and/or monitoring a project, in particular a building project, and/or a process, in particular a building use. In the present case, the system 10 is suitable and in particular intended for performing the method. The system 10 comprises a recording unit 14. In the present case, the system 10 comprises a plurality of recording units 14, 16, 18, only three of which are shown in exemplary fashion. However, the system 10 can comprise any number of recording units 14, 16, 18, for example 10 or 20 or 30 or 100 or any larger or smaller or intermediate number. The recording units 14, 16, 18 are intended to record parameter values of at least one parameter at at least one stipulable position 20, 22, 24 in the monitoring area in automated fashion. In particular, the recording unit 14 is intended to record parameter values of the parameter at a position 20 associated with said recording unit. The recording unit 14 is arranged at the position 20. In the present case, each position 20, 22, 24 to be monitored, just three of which are depicted in exemplary fashion, has one of the recording units 14, 16, 18 associated with it in each case. Further, in the present case, the recording units 14, 16, 18 are in at least substantially identical form to one another.

Alternatively, it is conceivable for a system to comprise recording units in different forms.

The system 10 further comprises at least one communication unit 30 and at least one external unit 32. The communication unit 30 is intended to transmit the parameter values to the external unit 32 in automated fashion. In the present case, the recording unit 14 has the communication unit 30. In particular, each of the recording units 14, 16, 18 has a communication unit 30 of its own in the present case. However, as mentioned above, it is also conceivable that parameter values of the parameter are recorded by means of a single recording unit at different positions and/or transmitted by means of a communication unit that is in a form external to a recording unit.

The recording unit 14 is in the form of an independent sensor beacon in the present case. Further, the recording unit 14 has a power supply of its own in the present case. The recording unit 14 is intended to record different parameter values of different parameters. By way of example, the recording unit 14, as also mentioned above, in particular, can be intended to record a temperature, an air pressure, an air humidity, a light intensity, a movement, a barcode, an RFID code, an identifier in general, a position, a GPS signal, an optical signal, an acoustic signal, a building progress, an image, a video image and/or the like. Preferably, the recording unit 14 is intended to repeatedly record the parameter values of the parameter, for example at intervals of time of a few seconds. Preferably, the communication unit 30 is intended to repeatedly transmit in particular current parameter values to the external unit 32, for example at intervals of time of a few seconds. In the present case, the recording unit 14 is intended to ascertain the parameter values in time-dependent fashion.

In the present case, the external unit 32 is in the form of a mobile terminal, for example in the form of a tablet PC or a smartphone or smart glasses or the like. In particular, the external unit 32 is a mobile terminal of a building site manager, structural engineer, manager, building manager, facility manager or the like. As mentioned above, it is also conceivable that an external unit is in the form of a server, part of an IT infrastructure, a cloud or the like. Further, it is conceivable that a server, an IT infrastructure and/or a cloud forms at least part of a computing unit of the external unit 32. The external unit 32 is intended to allow access to a BIM. The BIM can be stored in the external unit 32 and/or be operable by the external unit 32, at least in part. Alternatively, it is conceivable that the BIM is stored physically separately from the external unit 32, for example in a computing center, on a server, in a cloud or the like, and that the external unit 32 can be used to access the BIM, preferably wirelessly. The BIM is in the form of a data record comprising relevant information about the project. The BIM comprises all of the relevant information about the project. The BIM comprises information about personnel, tools, materials or the like that are needed for the project and/or comprises a schedule at least for completion of at least sections of the project and/or comprises further information that appears relevant to the project to a person skilled in the art.

The subarea 56 has a construction unit 64 arranged in it. The construction unit 64 is in the form of a machine tool. The construction unit 64 is in the form of a drill. Alternatively, it is conceivable that the construction unit 64 is in the form of a circular saw, in the form of an angle grinder, in the form of construction material, such as for example in the form of a window, pallet, insulating material or the like, in the form of a machine tool, such as for example in the form of a crane, in the form of a forklift truck, in the form of an excavator or the like, or in the form of a safety item, such as for example in the form of a riser, in the form of a parapet, in the form of railings or the like. The construction unit 64 comprises a further communication unit, not depicted further, at least for emitting a signal. The further communication unit is in the form of a wireless communication unit. The further communication unit is in the form of a WLAN module. Alternatively, it is conceivable that the further communication unit is in the form of a radio module, in the form of a Bluetooth module, in the form of an NFC module, in the form of a Zigbee module, in the form of a Wibree module or the like, that the further communication unit is intended for a data transmission by means of at least one optical transmission, for example by means of flashes of light and/or by means of infrared light, or that the further communication unit is in the form of a wired communication unit intended for communication with the recording unit 14, in particular with the communication unit 30 of the recording unit 14, via a cable connection, for example via an Ethernet connection or the like.

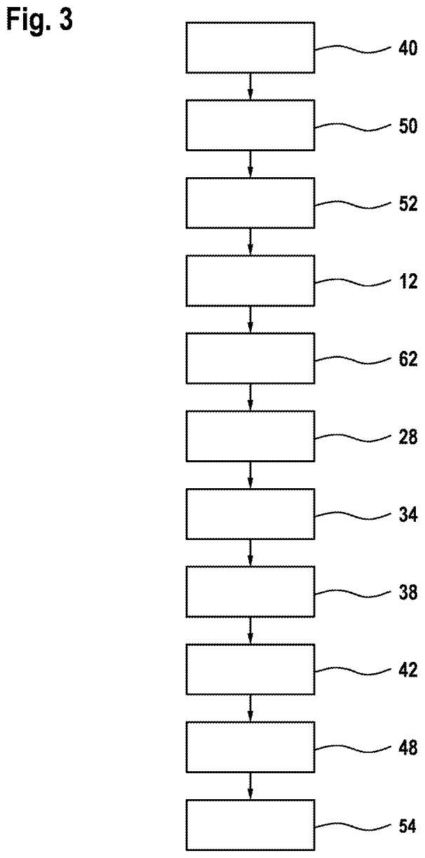

FIG. 3 shows a schematic flowchart for the method. The depiction of the method using sequentially proceeding method steps must be understood merely in exemplary fashion in this case. In general, it is conceivable that method steps proceed in an order different than the one described. Alternatively or additionally, it is conceivable that method steps proceed fully or in part at the same time and/or at overlapping times. Further, it is conceivable that at least one method step is carried out repeatedly.

At least one method step 12 involves the at least one recording unit 14, in particular the recording units 14, 16, 18, being used to record parameter values of at least one parameter at different stipulable positions 20, 22, 24 in the monitoring area 26 in automated fashion.

At least one method step 62 involves at least one parameter value of at least one parameter being recorded by means of the recording unit 14, in particular by means of the recording units 14, 16, 18, by means of an, in particular bidirectional, communication with the construction unit 64. The construction unit 64 has at least one parameter, such as for example a position of the construction unit 64, a state of charge of the construction unit 64, a genre of the construction unit 64, an identifier of the construction unit 64, a state of use of the construction unit 64 or the like. The recording unit 14, in particular the recording units 14, 16, 18, is intended to record a plurality of parameter values of parameters of a plurality of construction units 64, in particular of all the construction units 64 associated with the subarea 56. The construction unit 64 is intended at least to wirelessly emit a signal. The signal is recordable by the recording unit 14, in particular by the recording units 14, 16, 18. The signal comprises at least one parameter value of a parameter of the construction unit 64 in the form of electronic data.

The construction unit 64 is intended to use the further communication unit of the construction unit 64 to bidirectionally communicate with the recording unit 14, in particular with the recording units 14, 16, 18, via the communication units 30 of the recording units 14, 16, 18. The construction unit 64 is intended to use the further communication unit of the construction unit to receive signals of the communication units 30 of the recording units 14, 16, 18. The recording unit 14, in particular the recording units 14, 16, 18, is intended to use the communication unit 30 to selectively query at least one parameter value of a parameter of the construction unit 64. The recording unit 14, in particular the recording units 14, 16, 18, is intended to record the construction unit 64 according to the genre of the construction unit 64. The recording unit 14, in particular the recording units 14, 16, 18, is intended to use an identifier of the construction unit 64 to record the construction unit 64 as a dedicated element. The recording unit 14, in particular the recording units 14, 16, 18, is intended to use the identifier of the construction unit 64 to query at least one parameter value of at least one parameter of the construction unit 64, such as for example a specific property of the construction unit 64, a maintenance date for maintenance of the construction unit 64, a date of acquisition of the construction unit 64, a history of the construction unit 64 or the like, from a database. The external unit 32 is intended to access a database. Alternatively or additionally, it is conceivable that the external unit 32 is in the form of a database and/or comprises a database. The construction unit 64 is intended to provide a parameter value of a parameter of the construction unit by means of the further communication unit of the database, in particular to store it in the database.

At least one method step 28 involves the parameter values being transmitted to the external unit 32 by means of the communication unit 30, in particular by means of applicable communication units 30 of the recording units 14, 16, 18. In the present case, the parameter values are transmitted wirelessly, for example by means of Bluetooth or WLAN or the like, as in particular also mentioned above. In particular, the communication unit 30 is intended to make a data connection to multiple recording units 14, 16, 18, or to the respective communication units 30 thereof.

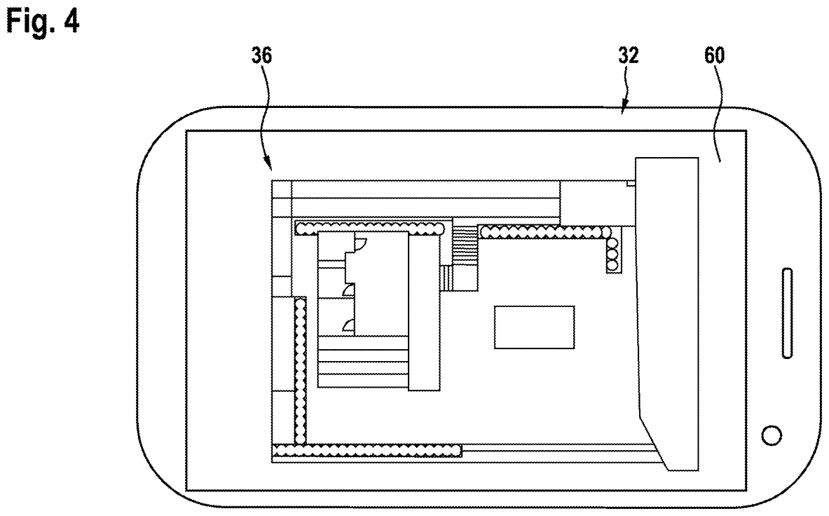

At least one method step 34 involves the external unit 32 being used to generate at least one blueprint 36 from at least the parameter values of the parameter. FIG. 4 shows a schematic depiction of the blueprint 36 on a display 60 of the external unit 32. The external unit 32, in particular the display 60 thereof, is intended to present the blueprint 36. In the present case, the external unit 32 executes an app via which a connection to the recording units 14, 16, 18 is able to be made and/or the parameter values are processable. In the present case, the parameter is a climatic parameter, for example a local air humidity. The blueprint 36 contains a spatially resolved depiction of a distribution of parameter values for the parameter within the monitoring area 26. In particular, the positions 20, 22, 24 of the recording units 14, 16, 18 are saved, for example in a memory of the external unit 32 and/or on a server or the like. The saved positions 20, 22, 24 are used in the method step 34 to locate the parameter values of the parameter, which are ascertained at different positions 20, 22, 24, within the blueprint 36. By way of example, in the present case, the blueprint 36 contains an air humidity map, with, as mentioned above, arbitrary other parameters, such as for example a movement of a group of construction units 64 and/or personnel or the like, being conceivable.

It is conceivable that an action dependent on the blueprint 36 is selectable, activable, and/or performable in automated fashion, by means of the external unit 32. At least partial closure or opening of the subarea 56 is performable by means of the external unit 32 on the basis of the blueprint 36. The external unit 32 can be used to open the subarea 56 at least for authorized personnel if the recording units 14, 16, 18 are used to ascertain a presence of all of the safety items, provided for in the BIM for the subarea 56, in the subarea 56. The external unit 32 can be used to close the subarea at least for a use of specific construction units 64 if the recording units 14, 16, 18 are used to ascertain a presence of hazardous materials, for example gasoline or the like, and/or of items at risk of damage, for example windows or the like, in the subarea 56. The external unit 32 can use the BIM to assign a work instruction and/or a place of use to personnel on the basis of work materials recorded by the recording units 14, 16, 18 at the place of use. In the absence of work materials provided for in the BIM at a place of use, the external unit 32 can assign another place of use to the personnel and/or initiate sourcing of work materials.

At least one method step 38 involves assigning to the blueprint 36 at least one piece of status information, a piece of progress information, a piece of use information and/or a piece of navigation information by means of the external unit 32 on the basis of the parameter values of the parameter. In the present case, for example a heat map is ascertained from the parameter values, said heat map using colored marking to depict areas of the monitoring area 26 having excessively high or excessively low air humidity values, for example. Further, it is conceivable that a general status parameter is ascertained and in particular depicted on the basis of the parameter values, which for example provides information about a general state of the monitoring area 26 in respect of the parameter. If for example the parameter is a material availability parameter, a warning can be output and/or a general status can be set for example to “material shortage” if there is the threat of a shortage of a material to be processed. If for example the parameter is a hazard parameter, such as for example a risk of accident in the monitoring area 26, the external unit 32 is intended to evaluate accidents recorded by means of the recording units 14, 16, 18, for example tripping, in the monitoring area 26 and to initiate countermeasures in automated fashion, for example to assign a risk of accident in the monitoring area 26 to the blueprint 36, to close the monitoring area or the like. Further, it is conceivable that the parameter is a building progress parameter that allows a local building progress to be ascertained, for example. The blueprint 36 can contain a building progress map, for example, in this case, in particular. The external unit is intended to use the BIM to ascertain whether the building progress is consistent with a schedule. The external unit 32 is intended to check, on the basis of the BIM and in the event of delayed building progress, whether deadline clashes arise and/or whether restructuring of work is necessary. The external unit can use the BIM to propose countermeasures, such as for example prioritization of tasks and/or work assignments, an assignment of a task force, an inspection by a site manager or the like, and/or to initiate them in automated fashion.

At least one method step 40 involves at least one time-dependent and/or location-dependent data record, which is independent of the parameter values of the parameter, being used to generate the blueprint 36. In the present case, the data record is for example a ground plan of the monitoring area 26. The data record can be created for example by means of an image recording, in particular using a camera of the external unit 32, of a ground plan. The data record can be used to create for example a map of the monitoring area 26 that is a basis for the blueprint 36 or is the blueprint 36. In particular, for example the heat map ascertained on the basis of the parameter values can be shown in this map in order to depict the blueprint 36.

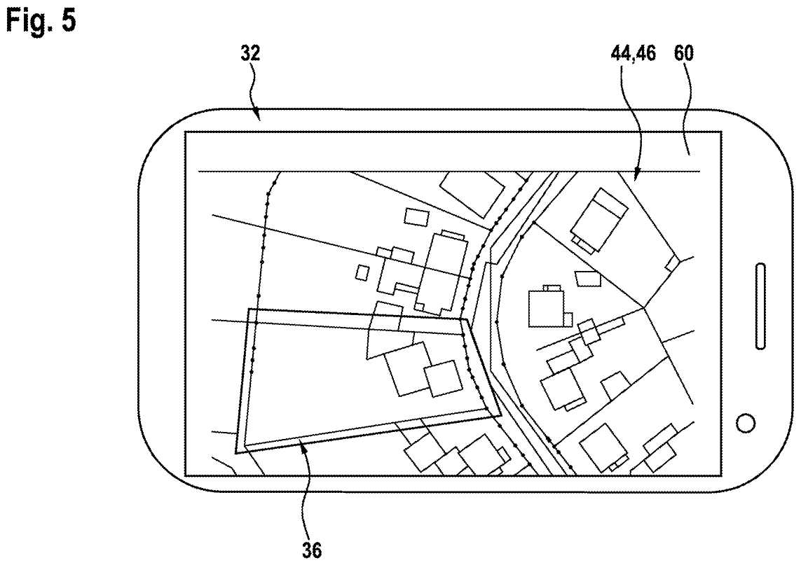

At least one method step 42 involves the external unit 32 being used to locate the blueprint 36 on the basis of at least one geoparameter 44. In the present case, the geoparameter 44 is a geographical map 46, for example. FIG. 5 shows a schematic depiction of the blueprint 36, located on the basis of the geoparameter 44. The blueprint 36 is shown in the existing geographical map 46 by means of the external unit 32. In particular, the geographical map 46 can be a digitally available geographical map and/or a geographical map usable for navigation by means of GPS, for example.

At least one method step 48 involves the recording unit 14, in particular the recording units 14, 16, 18, being used to record further parameter values of at least one further parameter, which is different than the parameter. Further, the blueprint 36 is generated from at least the further parameter values of the further parameter. In the present case, the further parameter is for example a building progress parameter. The further parameter values are used to create a building progress heat map that is depicted in particular together with the air humidity heat map in the blueprint 36. Any combinations of parameters are naturally conceivable in this case, and the depicted case of a combination of air humidity and building progress must be understood as purely exemplary. In particular, the external unit 32 is intended to provide at least one user guidance and/or to offer a user different depictions for selection, for example different and/or superposed maps, heat maps, parameter distributions and the like. Further, the external unit 32 is advantageously intended to depict a time characteristic of parameter values and/or information ascertained from the parameter values, for example a time characteristic, in particular at a specific position and/or in a specific, advantageously selectable area of the monitoring area 26, a building progress, a material availability, a work machine use, a room use, a room reservation or the like.

At least one method step 50 involves the external unit 32 being used to take at least one time-dependent and/or location-dependent data record, in particular the aforementioned data record, which is independent of the parameter values of the at least one parameter, as a basis for ascertaining at least one proposed positioning parameter for the recording unit 14, in particular for the recording units 14, 16, 18. In the present case, a number and/or type of recording units 14, 16, 18 used can be input by means of the external unit 32 and/or in particular recorded in automated fashion. Further, in the present case, as described above, a map is created on the basis of a detected ground plan. The external unit 32 is intended to depict proposed positioning parameters, in particular in the form of proposed positions 20, 22, 24 for the recording units 14, 16, 18, in the map. Before the parameter values are recorded by means of the recording units 14, 16, 18, a user of the system 10 positions the recording units 14, 16, 18 in accordance with the proposed positioning parameters, in particular at the positions 20, 22, 24. The external unit 32 can in this case be intended to stipulate the proposed positioning parameters on the basis of a signal strength to be expected, a use to be expected and/or another parameter to be expected, in particular in order to achieve advantageously complete coverage of the monitoring area 26 by recording units 14, 16, 18.

At least one method step 52 involves the external unit 32 being used to assign a position 20, 22, 24 of the recording unit 14, 16, 18 to at least one piece of information of the time-dependent and/or location-dependent data record, and in particular of the blueprint 36. In the present case, a unique ID of the recording units 14, 16, 18 is assigned to the respective positions 20, 22, 24 in accordance with a positioning of the recording units 14, 16, 18. An applicable piece of association information can be used to locate the parameter values in the blueprint 36. When a connection has been made, the external unit 32 can be used, as an alternative or in addition to the recording units 14, 16, 18, to create a navigable blueprint 36 and/or to locate said blueprint within a navigable geographical map 46. In this case, a navigation can be effected for example a navigation on the basis of a GPS signal and additionally on the basis of positioning information of the recording units 14, 16, 18. In particular in this case, the external unit 32 can comprise a server via which navigation information is retrievable from different terminals. It is alternatively conceivable that a navigation is effected by means of a suitable external unit 32, for example in the form of a wearable.

At least one method step 54 involves the external unit 32 being used to generate at least one process plan and/or at least one Gantt chart on the basis of the parameter values of the parameter. In particular, different parameters are used to create the process plan and/or the Gantt chart, in order to depict processes taking place within the monitoring area 26, in particular. Further, a process plan is advantageously converted into a Gantt chart, or vice versa, in automated fashion. This advantageously allows a process plan and a Gantt chart to be synchronized in automated fashion, it advantageously being sufficient to edit one of the two in order to make changes to both.

1. A method for one or more of managing and monitoring one or more of a project, and a process, comprising:
automatically recording parameter values of at least one parameter at different stipulable positions in a monitoring area via at least one recording unit; and
automatically transmitting the parameter values to at least one external unit via at least one communication unit.

2. The method as claimed in claim 1, wherein at least one parameter value of the at least one parameter is recorded via the recording unit by a communication with at least one construction unit.

3. The method as claimed in claim 1, wherein the external unit generates at least one blueprint from the parameter values of the at least one parameter.

4. The method as claimed in claim 3, wherein the external unit takes the parameter values of the at least one parameter as a basis for assigning to the blueprint one or more of at least one piece of status information, a piece of progress information, a piece of use information, and a piece of navigation information.

5. The method as claimed in claim 3, wherein at least one data record that is one or more of time-dependent and location-dependent, which data record is independent of the parameter values of the at least one parameter, is used to generate the blueprint.

6. The method as claimed in claim 3, wherein the external unit locates the blueprint on the basis of at least one geoparameter.

7. The method as claimed in claim 3, wherein the recording unit records further parameter values of at least one further parameter that is different than the at least one parameter, and wherein the blueprint is generated from the further parameter values of the at least one further parameter.

8. The method as claimed in claim 1, wherein the external unit takes at least one data record that is one or more of time-dependent and location-dependent, which data record is independent of the parameter values of the at least one parameter, as a basis for ascertaining at least one proposed positioning parameter for the recording unit.

9. The method as claimed in claim 8, wherein the external unit assigns a position of the recording unit to at least one piece of information of the data record.

10. The method as claimed in claim 1, wherein the external unit generates one or more of at least one process plan and at least one Gantt chart on the basis of the parameter values of the at least one parameter.

11. A system for one or more of managing and monitoring one or more of a project and a process comprising:
at least one recording unit configured to automatically record parameter values of at least one parameter at at least one stipulable position in a monitoring area; and
at least one communication unit configured to automatically transmit the parameter values to at least one external unit.

12. The method as claimed in claim 1, wherein the project is a building project and the process is a building use.

13. The method as claimed in claim 2, wherein the communication of the recording unit and the construction unit is bidirectional communication.

14. The method as claimed in claim 5, wherein the data record is at least one ground plan.

15. The method as claimed in claim 6, wherein the at least one geoparameter is at least one geographical map.

16. The system as claimed in claim 11, wherein the project is a building project and the process is a building use.
